(19) United States
(12) Patent Application Publication
(10) Pub. No.: US 2026/0239410 A1
(43) Pub. Date: Aug. 13, 2026

(54) METHOD AND APPARATUS FOR ADAPTIVE RESOURCE MANAGEMENT OF COMMUNICATIONS OF ONE USER EQUIPMENT TO ANOTHER USER EQUIPMENT

(71) Applicant: Continental Automotive Technologies GmbH, Hannover (DE)

(72) Inventors: Andreas ANDRAE, Frankfurt am Main (DE); Rikin SHAH, Langen, Hessen (DE); David GONZALEZ GONZALEZ, Egelsbach, Hessen (DE); Osvaldo GONSA, Frankfurt (DE)

(73) Assignee: Continental Automotive Technologies GmbH, Hannover (DE)

(21) Appl. No.: 19/156,050

(22) PCT Filed: Feb. 14, 2024
(86) PCT No.: PCT/EP2024/053670

§ 371 Date: Aug. 13, 2025

(30) Foreign Application Priority Data
Feb. 16, 2023 (DE) 10 2023 201 337.1

(51) Int. Cl. H04W 72/56; G08G 1/01; H04W 72/51

(52) U.S. Cl. CPC H04W 72/56; G08G 1/012; H04W 72/51

(57) ABSTRACT

A method for adaptive resource management of communications of one user equipment to another user equipment. At least one user equipment detects, using sensors, traffic objects in a geographical area. Then, traffic data analytics is performed on the detected traffic objects to obtain analyzed traffic data. Further, communication resource needs are identified based on the analyzed traffic data and the identified communication resource needs are prioritized. Finally, communication resources are allocated according to the prioritized communication resource needs. Also disclosed is a corresponding user equipment and a corresponding mobile network node.

### CROSS REFERENCE TO RELATED APPLICATIONS

This application is the U.S. National Phase Application of PCT International Application No. PCT/EP2024/053670, filed Feb. 14, 2024, which claims priority to German Patent Application No. 10 2023 201 337.1, filed Feb. 16, 2023, the contents of such applications being incorporated by reference herein.

### TECHNICAL FIELD

The invention relates to a method for adaptive resource management of communications of one user equipment to another user equipment. The invention further relates to a corresponding user equipment and a corresponding network node.

### BACKGROUND

Vehicle-to-everything (V2X) communications aim at enabling true cooperative automated driving with reduced number of accidents, increased road traffic efficiency with a decreased environmental footprint.

However, as an increased number of vehicles uses V2X communications, the demands on the spectrum for intelligent transport systems will significantly increase and channel congestion is expected. This may become, in particular, a problem when V2X communications do not work or do not work at the required speed and/or reliability in critical situations.

### SUMMARY

An aspect of the present invention is a method for adaptive resource management of communications of one user equipment to another user equipment that solves the above mentioned problems. A further aspect of the present invention is a corresponding user equipment and a corresponding mobile network node.

According to an aspect of the invention, a method for adaptive resource management of communications of one user equipment to another user equipment is provided.

In this context, communications of one user equipment to another user equipment are to be understood in the broadest sense. In particular, the communications of one user equipment to another user equipment may include, e.g., device-to-device communications, vehicle-to-everything (V2X) communications, proximity services, user equipment-to-network relaying, user equipment-to-user equipment relaying, and WiFi communications.

According to the method, traffic objects in a geographical area are detected by at least one user equipment using sensors. In this context, the geographical area may be a pre-defined geographical area or an adaptive geographical area. Examples for a pre-defined geographical area are an intersection or a highway interchange. As another example, a pre-defined geographical area may be the coverage area of a network node. An example for an adaptive geographical area is an area where a high traffic object density is observed, e.g., the area corresponding to a traffic jam.

Then, traffic data analytics is performed on the detected objects to obtain analyzed traffic data. Performing traffic data analytics may comprise that the detected traffic objects are classified. Said classification is, in particular, a classification according to a type of the traffic object. Performing traffic data analytics may further comprise that the identified traffic objects are tracked. That is, the motion of the identified traffic objects is followed to generate a trajectory of each of the identified traffic objects. Performing traffic data analytics may also comprise that future trajectories of the traffic objects are predicted. This prediction is made based on the trajectories obtained from the tracked traffic objects. The prediction may be further made based on other observables, such as turn indicators. Performing traffic data analytics may further comprise that incidents and/or criticalities are predicted. Such incidents and/or criticalities may comprise a local congestion, a traffic jam and/or an accident. Correspondingly, the analyzed traffic data may comprise classified traffic objects, tracked traffic objects, predicted future trajectories of the traffic objects, predicted incidents and/or predicted criticalities.

Based on the analyzed traffic data, communication resource needs are identified. That is, it is identified how much communication of one user equipment to another user equipment will have to take place, in particular within an area associated with an incident and/or a criticality.

Then, the identified communication needs of one user equipment to another user equipment are prioritized.

Finally, communication resources are allocated according to the prioritized communication resource needs. Said communication resources may be resources for communication of one user equipment to another user equipment. The communication resources may be a specified set of communication resources that is reserved for special purposes, in particular for communication during critical and/or safety-related events. The communication resources may be any radio resources in time, frequency, space, or code domain. As an example, the communication resources may correspond to radio resource blocks or subchannels dedicated to communications of one user equipment to another user equipment.

The steps of the method may be performed using computing devices, in particular computing devices with smart algorithms, and/or using artificial intelligence, such as deep neural networks.

By allocating the communication resources according to the prioritized communication resource needs, it is ensured that the communication resources are provided where and when the priority is the highest, i.e., where and when they are most needed. Hence, the communication resources are first used for communication in critical situations. Therefore, the risk that communications of one user equipment to another user equipment do not work or do not work at the required speed and/or reliability in critical situations is significantly reduced.

According to an embodiment, the communication resources comprise communication links, in particular downlink, uplink, sidelink resources, within a mobile network, in particular, but not limited to, a 5G and/or a 6G network and/or WiFi networks. While this seems to be the most relevant use case of the method as of today, it is understood, as mentioned above, that the method does not depend on the mobile network or on the WiFi network, but applies generally to a wide variety of networks.

According to an embodiment, the at least one user equipment is embedded in a smart infrastructure unit, a road side unit, a drone, an aerial platform, an unmanned aerial vehicle, a robot, and/or a vehicle. An example of a smart infrastructure unit and/or road side unit is a smart traffic light that is equipped with the necessary sensors and communication units. When such a smart traffic light is used, the geographical area may be an intersection to which said smart traffic light is allocated. Other smart infrastructure units and/or road side units in which the user equipment is embedded may be tunnels, street lights, electronically controlled road signage, guide posts, construction site surveillance units, or industrial facilities.

According to an embodiment, the sensors comprise cameras, lidar, radar, acoustic sensors, ultra-sonic sensors and/or radio sensors. Said radio sensors may use radio technologies for sensing, detection, ranging, and/or positioning and may use, e.g., ultra-wideband signals. In particular, measurements taken with different sensors may be combined to detect the traffic objects.

According to an embodiment, the traffic objects comprise vehicles, such as cars, trucks, busses, robots, and motorcycles, vulnerable road users, such as bicycles, scooters, wheelchairs, strollers, and pedestrians, and/or road obstacles, such as construction areas or other objects that may have an impact on the traffic and safety of traffic participants.

According to an embodiment, the method steps may be split between the at least one user equipment and a mobile network node. At the splitting point, the at least one user equipment sends intermediate data to the mobile network node.

Depending on the splitting point, the intermediate data is data specifying the detected traffic objects, the analyzed traffic data and/or data specifying the identified or prioritized communication resource needs. It is also possible that the step of performing traffic data analytics is split between the at least one user equipment and the mobile network node. In this case, the intermediate data is data specifying the classified traffic objects, the tracked traffic objects, the predicted future trajectories of the traffic objects, the predicted incidents and/or the predicted criticalities. The intermediate data may further comprise geo-reference or location data, specifying the location of the traffic objects and/or of the user equipment. The final step of allocating the communication resources is performed by the mobile network node. The mobile network nodes comprise terrestrial as well as non-terrestrial network nodes.

As an example, the steps of detecting the traffic objects as well as performing traffic data analytics are performed by the at least one user equipment. Then, the at least one user equipment sends intermediate data, which is, in this case, the analyzed traffic data, to the mobile network node. The mobile network node then performs the steps of identifying communication resource needs, prioritizing the identified communication resource needs and allocating the communication resources.

As another example, the steps of detecting the traffic objects, performing traffic data analytics, identifying communication resource needs and prioritizing the identified communication resource needs are performed by the at least one user equipment. Then, the at least one user equipment sends intermediate data, which is, in this case, data specifying the prioritized communication resource needs, to the mobile network node. The mobile network node then performs the step of allocating the communication resources.

According to an embodiment, the at least one user equipment sends user equipment capability data to the mobile network node. This is, in particular, performed before the detection of the traffic objects starts. The user equipment capability data comprises, in particular, information on the sensors (e.g., type, performance characteristics) of the user equipment, the computing capabilities (e.g., processing power, employed artificial intelligence/machine learning software release) of the user equipment and/or the communication capabilities (e.g., supported radio communication technologies) of the user equipment. The mobile network then configures, based on the user equipment capability data, the at least one user equipment to obtain and report the intermediate data to the mobile network node. Said reporting may be performed either continuously, based on a configured pattern, or event-based. The configuration may also include the configuration of the splitting point between the user equipment and the mobile network node. If, for example, the user equipment has both many sensors and high computing capabilities, performing many of the method steps by the user equipment is favorable. If, for another example, the user equipment has only few sensors and low computing capabilities, performing many of the method steps by the mobile network node is favorable. In the latter case, the mobile network node may collect intermediate data from more than one user equipment and then process this combined intermediate data.

According to an embodiment, the step of allocating communication resources is performed by at least one dedicated user equipment out of the at least one user equipment. In this case, the allocated communication resources are device-to-device communication resources. The dedicated user equipment may be, in particular, a smart infrastructure unit and/or a road side unit. In this case, the mobile network node does not perform any of the method steps. This case is particularly relevant in the absence of a network, i.e., when the user equipment is out of network coverage, or for special operational modes, such as, when at least one user equipment acts as a relay.

According to an embodiment, the step of identifying the communication resource needs comprises identifying local traffic hotspots and/or creating an incident heatmap. The identification of local traffic hotspots may be performed, e.g., by a clustering algorithm. In the incident heatmap, local traffic hotspots are indicated by a greater “temperature”. As a further example, a geographical map comprising multiple layers, such as, object type locations, predicted event and/or incident locations and predicted event criticalities, may be generated and used for prioritizing the identified communication resource needs and/or for allocating the communication resources.

According to an embodiment, the step of prioritizing the identified communication resource needs is performed based on criticality values assigned to potential incidents. As an example, a predicted severe accident will have a high criticality value, a predicted minor accident will have a medium criticality value and a predicted traffic jam will have a low criticality value.

Alternatively, or additionally, the step of prioritizing the identified communication resource needs is performed based on predetermined service priorities, e.g., for safety functions and for comfort functions. As an example, vehicle-to-vehicle communication pertaining to emergency braking will have a high service priority, whereas vehicle-to-relay user equipment communication for streaming of music will have a low service priority.

According to an embodiment, the step of allocating communication resources comprises sending a system information broadcast, dedicated radio resource control (RRC) reconfiguration messages, an emergency paging and/or an SSB signal. That is, there are several suitable ways to allocate the communication resources.

According to another aspect of the invention, a user equipment is provided. The user equipment is configured to send user equipment capability data to a mobile network node. It is further configured to receive configuration instructions from the mobile network node and apply said configuration instructions. The configuration instructions instruct the user equipment to obtain and report intermediate data to the mobile network node. Said intermediate data is data specifying detected traffic objects, analyzed traffic data and/or data specifying identified or prioritized communication resource needs. The intermediate data may further comprise geo-reference or location data. The user equipment is further configured to detect, using sensors, the traffic objects in a geographical area. Optionally, the user equipment is configured to perform traffic data analytics on the detected traffic objects to obtain the analyzed traffic data. The traffic data analytics may comprise classifying the traffic objects; tracking the traffic objects; and/or predicting future trajectories of the traffic objects, incidents and/or criticalities. The user equipment may further be configured to identify user equipment to user equipment communication resource needs based on the analyzed traffic data; prioritize the identified communication resource needs; and/or send the intermediate data to the mobile network node. Whether these steps are performed or not depends on which steps will be performed by the mobile network node. The intermediate data corresponds to the steps already performed by the user equipment. A more detailed description of this splitting of steps may be found in the above description. Also, the advantages and further embodiments correspond to those given in the above description.

According to an embodiment, the user equipment is embedded in a smart infrastructure unit, a road site unit, a drone, an aerial platform, an unmanned aerial vehicle, a robot, or a vehicle. An example of a smart infrastructure unit and/or road side unit is a smart traffic light that is equipped with the necessary sensors and communication units. When such a smart traffic light is used, the geographical area may be an intersection to which said smart traffic light is allocated. Other smart infrastructure units and/or road side units in which the user equipment is embedded may be tunnels, street lights, electronically controlled road signage, guide posts, construction site surveillance units, or industrial facilities. The user equipment may also be any other mobile device with integrated sensing capabilities, i.e., with the necessary sensors.

According to an embodiment, the user equipment is further configured to allocate communication resources according to the prioritized communication resource needs. In this case, the communication resources are device-to-device communication resources. Said allocation may be transmitted from the user equipment to other user equipment using device-to-device communication. The allocation of the communication resources by the user equipment is especially useful in the absence of a network, e.g., when the user equipment is out of coverage of a network. The allocation of the communication resources by the user equipment may also be used for specific operational modes, such as, when the user equipment is acting as a relay.

According to another aspect of the invention, a mobile network node is provided. The mobile network node is configured to receive, from at least one user equipment, user equipment capability data and to configure, based on the user equipment capability data, the at least one user equipment to obtain and report intermediate data. The intermediate data is data specifying detected traffic objects, analyzed traffic data and/or data specifying identified or prioritized communication resource needs. The intermediate data may further comprise geo-reference or location data. The mobile network node is further configured to receive, from the at least one user equipment, the intermediate data. Depending on which data the intermediate data comprises, i.e., which steps have already been performed by the at least one user equipment, the mobile network node is further configured to perform further traffic data analytics on the intermediate data received from the at least one user equipment to obtain analyzed traffic data; identify communication resource needs based on the analyzed traffic data; and/or prioritize the identified communication resource needs. Here, performing further traffic data analytics may comprise classifying the traffic objects; tracking the traffic objects; predicting future trajectories of the traffic objects; predicting incidents; and/or predicting criticalities. Finally, the mobile network node is configured to allocate communication resources according to the prioritized communication resource needs.

According to an embodiment, the mobile network node is a terrestrial or a non-terrestrial network node.

Further advantages and embodiments correspond to those given in the above description.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a schematic top view of an intersection with an embodiment of a user equipment and a mobile network node;

FIG. 2 shows a flowchart of an embodiment of a method for adaptive resource management of communications of one user equipment to another user equipment; and

FIG. 3 shows a flowchart of another embodiment of a method for adaptive resource management of communications of one user equipment to another user equipment.

In the figures, elements which correspond to elements already described may have the same reference numerals. Examples, embodiments or optional features, whether indicated as non-limiting or not, are not to be understood as limiting the invention as claimed.

### DESCRIPTION OF EMBODIMENTS

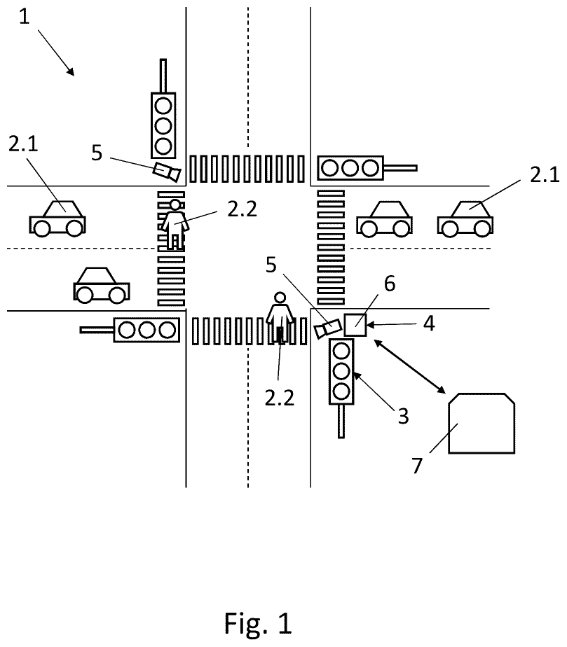

FIG. 1 shows a schematic top view of an intersection 1 with traffic objects 2. The intersection 1 is just an example of a geographical area with a traffic situation. The traffic objects 2 that are shown here are cars 2.1 and pedestrians 2.2, however, an aspect of the invention is not restricted to these traffic objects 2, but may encompass other traffic objects 2 such as other vehicles, e.g., trucks, busses, and motorcycles, other vulnerable road users, e.g., bicycles, scooters, wheelchairs and strollers, and/or road obstacles.

FIG. 1 further shows traffic lights as an example of a smart infrastructure unit 3. Besides the traffic lights, the smart infrastructure unit 3 comprises user equipment 4 with sensors 5, here shown as cameras, and a computing and communication unit 6. Other sensors 5 may be lidar, radar, acoustic sensors, ultra-sonic sensors and/or radio sensors. The computing and communication unit 6 may also be split into two separate units, one for computing and one for communication.

In alternative embodiments, the user equipment 4 may be embedded in a smart infrastructure unit, a road side unit, a drone, an aerial platform, an unmanned aerial vehicle, and/or a vehicle.

The user equipment 4 communicates with a mobile network node 7. In alternative embodiments, e.g., if the user equipment 4 is out of network coverage, the mobile network node 7 may be omitted.

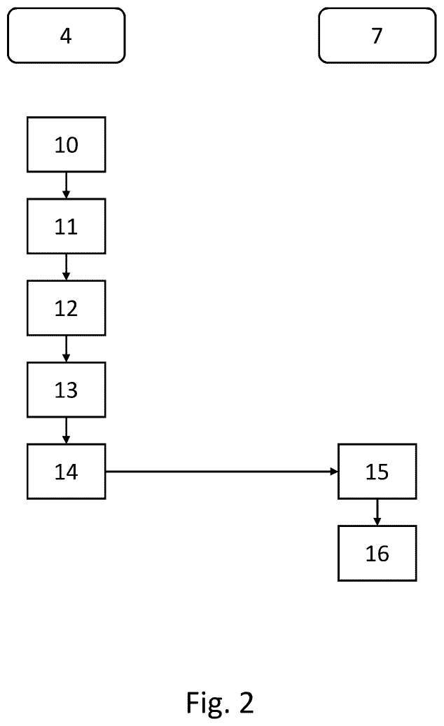

The user equipment 4 and the mobile network node 7 are configured to perform the method shown in FIG. 2.

FIG. 2 shows a flowchart of an embodiment of a method for adaptive resource management of communications of one user equipment to another user equipment. In this context, the “one user equipment” and “another user equipment” may be user equipment embedded in traffic objects, in particular in vehicles such as cars, trucks, busses and motorcycles, smart infrastructure units, road side units, drones, aerial platforms and/or unmanned aerial vehicles.

According to the method, the user equipment 4 detects 10, using the sensors 5, traffic objects 2 in the vicinity of the intersection. The user equipment 4 then performs traffic data analytics 11 on the detected traffic objects 2 to obtain analyzed traffic data. Here, performing traffic data analytics 11 may comprise classifying the traffic objects 2, tracking the traffic objects 2, predicting future trajectories of the traffic objects 2, predicting incidents and/or predicting criticalities. Then, the user equipment 4 identifies 12 communication resource needs based on the analyzed traffic data. Further, the user equipment 4 prioritizes 13 the identified communication resource needs.

Then, the user equipment 4 sends 14 intermediate data, which in this case comprises data specifying the prioritized communication resource needs to the mobile network node 7. The mobile network node 7 receives the intermediate data and allocates 16 communication resources according to the prioritized communication resource needs.

This way, it is ensured that the communication resources are provided where and when the priority is the highest, i.e., where and when they are most needed. Hence, the communication resources are first used for communication in critical situations. Therefore, the risk that communications of one user equipment to another user equipment do not work or do not work at the required speed and/or reliability in critical situations is significantly reduced.

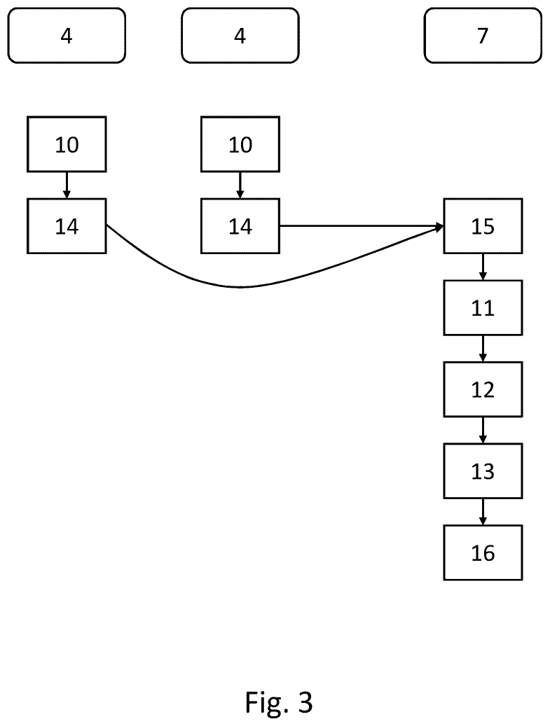

FIG. 3 shows a flowchart of another embodiment of a method for adaptive resource management of communications of one user equipment to another user equipment. While the embodiment shown in FIG. 2 is particularly useful when the user equipment 4 is powerful in terms of sensors 5 and computing capabilities, such as user equipment 4 of a smart infrastructure unit 3, the embodiment shown in FIG. 3 is particularly useful when the user equipment 4 is less powerful in terms of sensors 5 and/or computing capabilities.

According to the method, two pieces of user equipment 4 detect 10, using the sensors 5, traffic objects 2 in the vicinity of the intersection. Both pieces of user equipment 4 then send 14 intermediate data, which in this case comprises data specifying the detected traffic objects 2, to the mobile network node 7.

The mobile network node 7 receives 15 the intermediate data, combines the data specifying the detected traffic objects 2 and performs traffic data analytics 11 on the detected traffic objects 2 to obtain analyzed traffic data. As above, performing traffic data analytics 11 may comprise classifying the traffic objects 2, tracking the traffic objects 2, predicting future trajectories of the traffic objects 2, predicting incidents and/or predicting criticalities. Then, the mobile network node 7 identifies 12 communication resource needs based on the analyzed traffic data and prioritizes 13 the identified communication resource needs. Finally, the mobile network node 7 allocates 16 communication resources according to the prioritized communication resource needs.

Other variations to the disclosed embodiments can be understood and effected by those skilled in the art in practicing the claimed invention, from the study of the drawings, the disclosure, and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

### LIST OF REFERENCE SIGNS

1 intersection
2 traffic object
2.1 car
2.2 pedestrian
3 smart infrastructure unit
4 user equipment
5 sensor
6 computing and communication unit
7 mobile network node
10 detecting
11 performing traffic data analytics
12 identifying
13 prioritizing
14 sending
15 receiving
16 allocating

1. A method for adaptive resource management of communications of one user equipment to another user equipment, comprising:
detecting, by at least one user equipment using sensors, traffic objects in a geographical area;
performing traffic data analytics on the detected traffic objects to obtain analyzed traffic data;
identifying communication resource needs based on the analyzed traffic data;
prioritizing the identified communication resource needs; and
allocating communication resources according to the prioritized communication resource needs.

2. The method according to claim 1, wherein the communication resources comprise communication links within a mobile network, in particular a 5G and/or a 6G network, and/or WiFi networks.

3. The method according to claim 1, wherein the at least one user equipment is embedded in a smart infrastructure unit, a road side unit, a drone, an aerial platform, an unmanned aerial vehicle, a robot, and/or a vehicle.

4. The method according to claim 1, wherein the sensors comprise cameras, lidar, radar, acoustic sensors, ultra-sonic sensors and/or radio sensors.

5. The method according to claim 1, wherein the traffic objects comprise vehicles, such as cars, trucks, busses, robots, and motorcycles, vulnerable road users, such as bicycles, scooters, wheelchairs, strollers, and pedestrians, and/or road obstacles.

6. The method according to claim 1, wherein the at least one user equipment sends intermediate data to a mobile network node, and allocating the communication resources is performed by the mobile network node, wherein the intermediate data is, in particular, data specifying the detected traffic objects, the analyzed traffic data and/or data specifying the identified or prioritized communication resource needs and further comprises geo-reference or location data.

7. The method according to claim 6, wherein the at least one user equipment sends user equipment capability data to the mobile network node, the mobile network node configures, based on the user equipment capability data, the at least one user equipment to obtain and report the intermediate data to the mobile network node, in particular continuously, based on a configured pattern, or event-based.

8. The method according to claim 1, wherein the step of allocating communication resources is performed by at least one dedicated user equipment, in particular a smart infrastructure unit and/or a road side unit, out of the at least one user equipment.

9. The method according to claim 1, wherein the step of identifying the communication resource needs comprises identifying local traffic hotspots and/or creating an incident heatmap.

10. The method according to claim 1, wherein prioritizing the identified communication resource needs is performed based on criticality values assigned to potential incidents and/or predetermined service priorities, e.g., for safety functions and for comfort functions.

11. The method according to claim 1, wherein the step of allocating communication resources comprises sending a system information broadcast, dedicated radio resource control reconfiguration messages, an emergency paging and/or an SSB signal.

12. A user equipment, configured to:
send user equipment capability data to a mobile network node;
receive, from the mobile network node, and apply configuration instructions to obtain and report intermediate data to the mobile network node, wherein the intermediate data is data specifying detected traffic objects, analyzed traffic data and/or data specifying identified or prioritized communication resource needs and further comprises geo-reference or location data;
detect, using sensors, traffic objects in a geographical area; and, optionally,
perform traffic data analytics on the detected traffic objects to obtain the analyzed traffic data;
identify communication resource needs based on the analyzed traffic data;
prioritize the identified communication resource needs; and/or
send the intermediate data to the mobile network node.

13. The user equipment according to claim 12, wherein the user equipment is embedded in a smart infrastructure unit, a road side unit, a drone, an aerial platform, an unmanned aerial vehicle, a robot, or a vehicle.

14. The user equipment according to claim 12, wherein the user equipment is further configured to allocate communication resources according to the prioritized communication resource needs.

15. A mobile network node, configured to:
receive, from at least one a user equipment, user equipment capability data;
configure, based on the user equipment capability data, the at least one user equipment to obtain and report intermediate data, wherein the intermediate data is data specifying detected traffic objects, analyzed traffic data and/or data specifying identified or prioritized communication resource needs and further comprises geo-reference or location data;
receive, from the at least one user equipment, the intermediate data;
perform further traffic data analytics on the intermediate data received from the at least one user equipment to obtain analyzed traffic data;
identify communication resource needs based on the analyzed traffic data; and/or
prioritize the identified communication resource needs; and
allocate communication resources according to the prioritized communication resource needs.
